(19) United States
(12) Patent Application Publication
(10) Pub. No.: US 2016/0297130 A1
(43) Pub. Date: Oct. 13, 2016

(54) Melt Control in an Injection Molding System

(71) Applicant: HUSKY INJECTION MOLDING SYSTEMS LTD., Bolton (CA)

(72) Inventors: Brian ESSER, Colchester, VT (US); Angelo MIER, Colchester, VT (US); John KNAPP, St. Albans, VT (US); Edward Joseph JENKO, Essex, VT (US)

(21) Appl. No.: 14/777,537

(22) PCT Filed: Mar. 12, 2014
(86) PCT No.: PCT/US14/23843

§ 371 Date: Sep. 16, 2015

Related U.S. Application Data
(60) Provisional application No. 61/802,777, filed on Mar. 18, 2013.

(51) Int. Cl. B29C 45/78; B29C 45/12; B29C 45/27

(52) U.S. Cl. CPC B29C 45/78; B29C 45/2725; B29C 45/2738; B29C 45/125; B29C 2945/7604; B29C 2945/7613; B29C 2945/761; B29C 2945/76107; B29C 2945/76257; B29C 2945/76381; B29C 2945/76531; B29C 2945/76688; B29C 2945/76859; B29C 2945/76936

(57) ABSTRACT

Injection molding systems described herein are configured to produce more uniform injection molded parts in one or more mold cavities corresponding to nozzles of a hot runner. The injection molding systems include sensors that detect one or more physical properties of a melt having been dispensed into the respective one or more mold cavities. A controller is configured to adjust the heat output from one or more heaters based on the sensed physical properties of the dispensed melt. Further, each nozzle of a hot runner may include a balance heater for heating an area of the nozzle body and a tip heater for heating an area of the nozzle tip. The controller of the injection molding system is configured to independently adjust the heat output of each balance heater of the hot runner.

### FIELD

Aspects of the present disclosure relate generally to injection molding systems and processes for controlling a melt flow through an injection molding system.

### DISCUSSION OF RELATED ART

Injection molding systems typically include a hot runner through which molten plastic flows and is dispensed into a number of mold cavities that are specifically shaped in accordance with the type of parts to be manufactured. Hot runners include a manifold having a melt channel that branches into a number of nozzles, each of the nozzles having tips that are aligned with the entrance of corresponding mold cavities. Hot runners are equipped with a number of heated components used for controlling flow of the molten plastic through the various channels and out the nozzles. Upon entry of a melt into the hot runner, the manifold distributes the melt stream into separate nozzles. Each of the nozzles then dispense the melt into corresponding mold cavities.

Hot runner controllers have incorporated closed loop temperature feedback control of heater components at various locations of the hot runner itself; such locations may be, for example, along the manifold and around the nozzles. Open loop control has also been used where a particular set of parameters are input into the controller system and the heater components are set in accordance with those parameters without closed loop feedback. Parts composed of plastic materials that are produced from an injection molding system are often inspected manually, such as based on observation, after the melt stream is dispensed from respective nozzles and into mold cavities.

### SUMMARY

The inventors have appreciated that it would be beneficial for injection molding systems to be configured to produce uniformly molded parts in an effective and efficient manner. In some systems, melt is fed from a hot runner to produce identical parts in a multitude of corresponding mold cavities in a mold. As such, it may be desirable that a physical characteristic of the melt in each cavity be balanced during production so that the resulting parts are essentially identical. In embodiments discussed herein, a feedback control system is provided to aid in balancing the amount of melt dispensed from separate nozzles of a hot runner based on physical properties (e.g., structural properties or otherwise) sensed from melt that was already dispensed into corresponding mold cavities. For example, such physical/structural properties may be sensed from melt in the mold cavities during and/or after injection into the cavities. Or, as another example, the physical/structural properties of the dispensed melt may be sensed from the molded part itself during and/or after ejection from the cavities. In this regard, the sensed property may be sensed during the current cycle and/or at the completion of the prior cycle. Injection molding systems may be configured for appropriate adjustments to be made (manually or automatically) during or after an injection molding cycle such that the rate at which melt is dispensed from each of the nozzles into respective mold cavities (which may also be a sensed physical/structural property) and/or the amount of dispensed melt into each of the mold cavities is substantially equal, at any given time during and/or after production.

In some embodiments, injection molding systems include individual balance heaters corresponding to each of the nozzles of the hot runner. The balance heaters regulate the rate at which a melt stream flows through the nozzles and, hence, the amount of material that is ultimately dispensed into the mold cavities. A controller may provide for individual adjustment of the heat output from each of the balance heaters. As stated above, this adjustment in heat output may be based on sensed physical properties (e.g., structural properties) of a melt that has been dispensed from each of the respective nozzles (e.g., in a melted phase or the molded part itself), to control an amount of melt that is ultimately dispensed into corresponding mold cavities, for uniform production of injection molded parts. Alternatively, as discussed, adjustment of heat output may be based on a sensed physical property of melt in a prior injection cycle and/or article resulting from the prior injection cycle.

So that the melt flowing into the cavities is balanced across all cavities, a structural property, such as the weight, rate of flow, certain dimensions and/or volume of the dispensed melt in one mold cavity is measured and compared with a structural property of the dispensed melt measured in another mold cavity. In some instances, this structural property may be compared to one or more standard reference values that the dispensed melt is to be modeled after. Based on this comparison, one or more appropriate heaters (e.g., balance heaters, nozzle heaters, manifold heaters, supplemental heaters, other heaters) are adjusted so as to increase or decrease the heat output to one or both of the corresponding nozzles, affecting the temperature of the melt flowing through the nozzle(s). This adjustment in heat output provides for balancing of the dispensed melt between separate mold cavities, resulting in uniformly produced injection molded parts from the hot runner.

In some embodiments, a tip heater, separate from a balance heater, is positioned adjacent to a tip of the nozzle for controlling the quality of the melt upon exit from the tip of the nozzle. Balance heaters and tip heaters may be independently controlled such that control of the amount of melt dispensed into a mold cavity is decoupled from control of the quality of the melt that exits from the tip of the nozzle. Further, individual balance heaters, or small groups of balance heaters, within a hot runner may also be independently controlled so as to precisely control relative amounts of melt dispensed into different mold cavities.

In an illustrative embodiment, an injection molding system is provided. The system includes a hot runner including: a plurality of nozzles, each constructed and arranged to dispense a melt into one or more corresponding mold cavities, each nozzle having a nozzle body and a nozzle tip coupled to the body, and a plurality of heaters, each constructed and arranged to heat the melt in at least one corresponding nozzle of the plurality of nozzles. The system further includes at least one sensor configured to sense a structural property of the dispensed melt of each of the one or more mold cavities; and a heater controller configured to adjust a heat output of the plurality of heaters based on the sensed structural property of the dispensed melt of each of the one or more mold cavities.

In another illustrative embodiment, a process of controlling a melt in an injection molding system having a plurality of nozzles is provided. The process includes dispensing the melt from a plurality of nozzles into one or more mold cavities each corresponding to a separate nozzle; sensing a structural property of the dispensed melt of each of the one or more mold cavities; and adjusting a heat output of at least one heater based on the sensed structural property of the dispensed melt of each of the one or more mold cavities.

In a different embodiment, an injection molding system is provided. The system includes a hot runner including: a plurality of nozzles, each constructed and arranged to dispense a melt into one or more corresponding mold cavities, each nozzle having a nozzle body and a nozzle tip coupled to the body, a plurality of balance heaters, each constructed and arranged to heat an area of a nozzle body of a corresponding nozzle, and a plurality of tip heaters, each constructed and arranged to heat an area of a nozzle tip of a corresponding nozzle. The system further includes a heater controller configured to adjust a heat output of each balance heater independently of each other.

In yet another embodiment, a process of controlling a melt in an injection molding system is provided. The process includes dispensing the melt from a plurality of nozzles into a one or more corresponding mold cavities each corresponding to a separate nozzle; adjusting a heat output of each of a plurality of balance heaters corresponding to each of the plurality of nozzles to heat an area of a nozzle body of the corresponding nozzle independently of each other; and adjusting a heat output of each of a plurality of tip heaters corresponding to each of the plurality of nozzles to heat an area of a nozzle tip of the corresponding nozzle.

Advantages, novel features, and objects of the invention will become apparent from the following detailed description of the invention when considered in conjunction with the accompanying drawings, which are schematic and which are not intended to be drawn to scale. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

The accompanying drawings are not intended to be drawn to scale. In the drawings, each identical or nearly identical component that is illustrated in various figures is represented by a like numeral. Various embodiments of the invention will now be described, by way of example, with reference to the accompanying drawings, in which:

FIG. 1 shows a cross sectional view of a conventional injection molding system;

FIG. 2 depicts a cross sectional view of an injection molding system in accordance with some embodiments;

FIG. 3 shows a cross sectional view of another injection molding system in accordance with some embodiments;

FIG. 4 illustrates a schematic of a control architecture of an injection molding system in accordance with some embodiments; and

FIG. 5 shows a process flow diagram of operation of an injection molding system in accordance with some embodiments.

### DETAILED DESCRIPTION

The present disclosure relates to injection molding systems that are configured to produce injection molded parts uniformly using part-based feedback from sensed property information detected during or after the injection cycle. In particular, injection molding systems described herein implement a control system that provides for uniform amounts of melt to be dispensed from multiple nozzles of a hot runner and into one or more mold cavities corresponding to each of the nozzles. For example, one or more cavities may be employed in producing a molded part and melt from a hot runner may flow into each cavity.

The inventors have recognized that it is common for non-uniformities to exist in injection molded parts produced from a hot runner, hence, yielding poor quality parts. Such non-uniformities are due, at least in part, to varying conditions to which the melt is exposed while in the hot runner. For example, a stream of melt will travel a longer overall distance to nozzles located at the periphery of a hot runner as compared to nozzles located at a more central region of the hot runner. Or, the rate of flow of melt at one location of the hot runner may differ from the rate of flow at another location, which affect the rate of fill into various mold cavities. Such conditions may give rise to inconsistent formation of injection molded parts (or inconsistent delivery into a mold cavity) upon dispense from separate nozzles of the hot runner.

The present disclosure relates to a system level approach for better optimizing control of melt flow through various zones of a hot runner. By taking zone to zone interactions into account, thermal solutions discussed herein may be helpful to increase system design flexibility by, at least in part, correcting for subtle sources of imbalance that may otherwise be native to hot runner systems.

Individual heaters incorporated and positioned at certain locations throughout the hot runner may be set according to particular parameters and may further be subject to continual/periodic adjustment (e.g., based on controller feedback) so as to produce uniform injection molded parts. Such adjustment(s) may be based on sensed properties of the dispensed melt. As provided herein, the dispensed melt from which various physical/structural properties are sensed may, for example, be melt that is in the process of being dispensed into mold cavities, melt that has already been dispensed into the mold cavities, melt that has formed into one or more molded parts while in the mold cavities, and/or melt that has formed into one or more molded parts during ejection or having been ejected from the mold cavities. Various properties of the dispensed melt may include, for example, the weight of the dispensed melt during or after production, measurable dimensions/volume of the dispensed melt at various points during processing, flow rate of the melt at different stages of production (e.g., fill rate of the mold cavities), etc.

For injection molding systems described herein, appropriate heating adjustments may be made, automatically or manually, at specific areas of the hot runner so that the amount of melt that is dispensed from each of the nozzles into respective mold cavities is substantially equal. Such heating adjustments may be made to any appropriate heater located at any point along the hot runner, for example, balance heaters, tip heaters, nozzle heaters, manifold heaters, supplemental heaters, etc. Accordingly, melt flow through various regions of the hot runner, such as the manifold or nozzle, may be adjusted so that injection molded parts may be produced uniformly and in an efficient manner.

Injection molding systems described herein may include a hot runner having a manifold with a melt channel through which a melt introduced into the hot runner may flow. The melt channel of the manifold may branch off into multiple channels corresponding to separate nozzles into which the melt may be distributed.

In some embodiments, associated with each nozzle is a balance heater, for heating the body of the nozzle, and a tip heater, for heating the tip of the nozzle. At least a portion of the balance heater may be located adjacent to and/or may surround the body of the nozzle; and at least a portion of the tip heater may be located adjacent to and/or may surround the tip of the nozzle.

One or more parameters (e.g., power/heat output) of the balance heater may be adjusted so as to control heat input to a melt flowing through the body of the nozzle. As the temperature of the melt within the nozzle is raised, or lowered, the rate at which the melt flows through the nozzle channel and, ultimately, the amount of melt that is dispensed into a corresponding mold cavity at any given time may be affected.

One or more parameters (e.g., power/heat output) of the tip heater may also be adjusted so as to raise or lower the temperature of the melt at the tip of the nozzle. Such an adjustment assists in controlling the quality of the melt so that, upon exiting from the tip of the nozzle and entering into a corresponding mold cavity or section of a mold cavity, the melt maintains a desirable consistency.

In some embodiments, balance heaters and tip heaters are independently controlled such that control of the amount of melt dispensed into a mold cavity over a given period of time is decoupled from control of the quality of the melt that exits from the tip of the nozzle. For example, adjustments to the flow rate and the amount of melt that exits out of the nozzle may be made without having to alter the heat setting of the tip heater(s) located at the nozzle tip. Conversely, the heat output of the tip heater may be adjusted to ensure that the melt having a desired consistency and quality, without having to adjust the amount of melt that exits out of the nozzle over a period of time, as controlled by the balance heater. In addition, each of the balance heaters, or small subsets of balance heaters, corresponding to respective nozzles, may be independently controlled so that even slight adjustments to the amount of melt flowing from individual nozzles over a given period of time may be made.

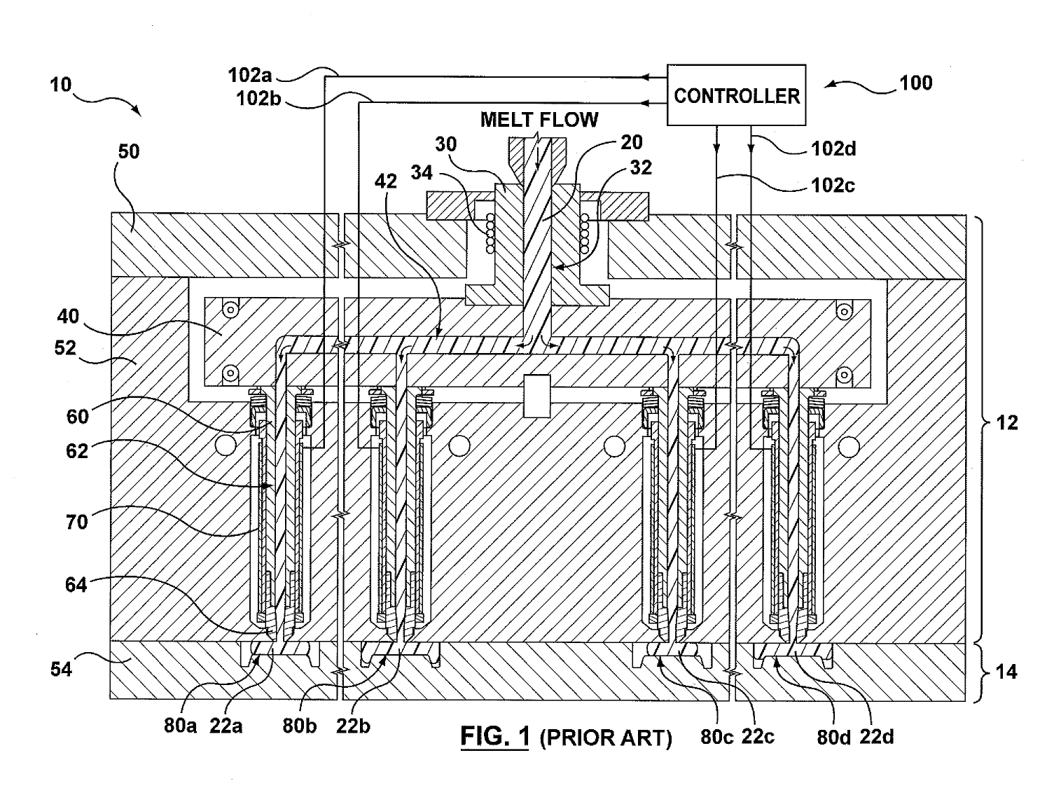

FIG. 1 shows a conventional injection molding system 10 for the production of injection molded parts from a melt 20. The injection molding system includes a hot runner 12 with a number of nozzles positioned in alignment with corresponding mold cavities 14. The hot runner 12 includes a sprue bushing 30 having a channel 32 through which the melt enters. A heater 34 surrounds a portion of the sprue bushing. The heater 34 generates heat so as to maintain an appropriate temperature within the sprue bushing for the melt to flow toward the manifold 40. It should be appreciated that multiple mold cavities to create a multitude of molded parts, or a single mold cavity to create a large molded part may be employed, such that depending on context, “mold cavities” may refer to a plurality of mold cavities or a plurality of sections of a single mold cavity.

The manifold 40 is supported on opposite sides by manifold plates 50, 52. The manifold 40 includes a channel 42 through which the melt flows. The channel 42 branches off into separate passageways for distribution of the melt to separate nozzles 60. The hot runner may include any suitable number of nozzles, such as 4 nozzles, 8 nozzles, 10 nozzles, 16 nozzles, 20 nozzles, 32 nozzles, etc., each arranged to dispense melt into a corresponding mold cavity 80. In some embodiments, multiple nozzles (e.g., 2, 3, 4 or more nozzles) may be arranged to dispense melt into the same mold cavity (this particular arrangement is not shown in the figures).

Each nozzle 60 includes a nozzle body having a channel 62 and a nozzle tip 64 disposed at the end of the nozzle body. Melt 20 distributed from the manifold into each nozzle flows through the channel 62 and out the tip 64 of the respective nozzle toward corresponding mold cavities 80. A heater 70 is disposed adjacent to and surrounds a portion of the nozzle. The heater 70 generates heat so as to maintain the melt flowing through the channel 62 at an appropriate temperature within the nozzle and for exit out the tip 64 toward the mold cavities 80.

As shown in the figure, a mold plate 54 supports each of the mold cavities 80a, 80b, 80c, 80d against manifold plate 52. The melt is dispensed from each of the respective nozzles and flows into the space provided by each of the corresponding mold cavities.

The controller 100 provides signals to the heaters 70 for raising, lowering and/or maintaining the temperature of each of the respective nozzles and of the melt within the nozzles. In some embodiments, transmission lines 102a, 102b, 102c, 102d provide signals from the controller to respective heaters 70. Accordingly, the temperature of the nozzles 60 are kept at a certain range based on the heat input into the heaters 70.

The temperature conditions of each nozzle ultimately affect the amount of melt 22 that is dispensed into each mold cavity 80. For example, temperature conditions may affect the rate at which the melt flows through the nozzle and, hence, the rate of fill into the mold cavities and the amount of dispensed melt that ultimately flows into each mold cavity. Temperature conditions at certain regions within each nozzle may also affect the quality of melt that is dispensed into the mold cavity, such as the uniformity of the melt as it exits out of the tip of the nozzle. In FIG. 1, any adjustments to the heater 70 affects both the amount of dispensed melt that flows into each mold cavity and the quality of the melt upon exit from the nozzle.

As shown in FIG. 1, the amount of dispensed melt 22a, 22b, 22c, 22d into each of the mold cavities 80a, 80b, 80c, 80d is substantially different. This leads to non-uniformity of the injection molded parts. For example, as depicted, the dispensed melt 22a, 22c in mold cavities 80a, 80c is less than the dispensed melt 22b, 22d in mold cavities 80b, 80d. Thus, if the existing heating conditions are maintained, then despite each of the mold cavities providing an identical space in which identical parts may be formed, due to variations in the amount of melt dispensed, the final injection molded parts will differ, undesirably so.

The inventors have recognized that prior injection molding systems do not automatically incorporate physical property information measured directly from the dispensed melt in the mold cavity itself. Instead, an operator would have to manually inspect the part upon ejection from the mold cavity to determine whether heaters within the hot runner should be adjusted. Accordingly, injection molding systems described herein may incorporate a number of sensors for sensing various physical properties, structural or otherwise, of the dispensed melt of each of the mold cavities. Such information may be used to determine whether heaters within the hot runner should be adjusted (whether during an injection cycle or upon the next or subsequent injection cycle) to maintain uniformity in the production of the injection molded parts.

In some embodiments, certain sensors described herein are positioned in or near each of the mold cavities so as to sense various physical properties of the melt having been dispensed from the tip of each of the nozzles. For example, such physical properties may be structural properties which can include the weight of the dispensed melt (e.g., before and/or after solidification from a molten state, during or after production), certain dimensions of the dispensed melt while in the mold cavity (e.g., the length/width/thickness of a partially filled injection molded part), the volume of the dispensed melt, the flow rate of the melt into the mold cavity (i.e., rate of fill of the mold cavity), or other structurally related properties. Other physical properties that are not structural in nature may be sensed, such as the temperature or pressure of the melt at various regions within the injection molding system. In some embodiments, multiple sensors may be associated with a single relatively large mold cavity (e.g., a mold cavity into which multiple nozzles are configured to dispense melt) where the sensor(s) are configured to detect physical properties in different regions of the relatively large mold cavity.

While sensors may provide physical and structural property information of the melt in the mold cavities, it can be appreciated that other sensors may be distributed throughout the injection molding system. Such sensors may be located at different regions of the hot runner for monitoring various characteristics of the melt (e.g., temperature, pressure, flow rate, etc.) at certain points within the hot runner (e.g., within the sprue, melt channel, nozzles, etc.).

Sensors throughout the system may be appropriate for measuring properties of the dispensed melt at any suitable stage. For instance, properties of the dispensed melt may be sensed while the melt is being dispensed into mold cavities (e.g., determining the rate of flow into mold cavities), when the melt has already been dispensed into the mold cavities (e.g., weight/dimensions of the melt), when the melt has been formed (e.g., solidified) into the molded part(s) (e.g., before, during or after removal from the mold cavities).

The injection molding system may include a heater controller that sends and receives signals that result in suitable adjustment of the heat output of balance/tip heaters that correspond to each of the plurality of nozzles, and/or other appropriate heaters located throughout the hot runner. For example, the heater controller may receive a signal from a number of sensors indicating that the weight of the dispensed melt within one of the mold cavities is less than that measured in the other mold cavities. Accordingly, the heater controller may make a determination of how much heat is required from the balance heater corresponding to the particular nozzle that dispensed a deficient amount of melt so that an appropriate adjustment may be made. The heater controller may also appropriately adjust the heat output of one or more other heaters located throughout the hot runner to achieve a desired result. Such an adjustment may result in the dispensed melt within that mold cavity to increase sufficiently so that the total dispensed melt distributed across all mold cavities is suitably balanced. The heater controller may then make a determination that the heat output of the relevant balance heater(s), and/or other heater(s), have been appropriately adjusted.

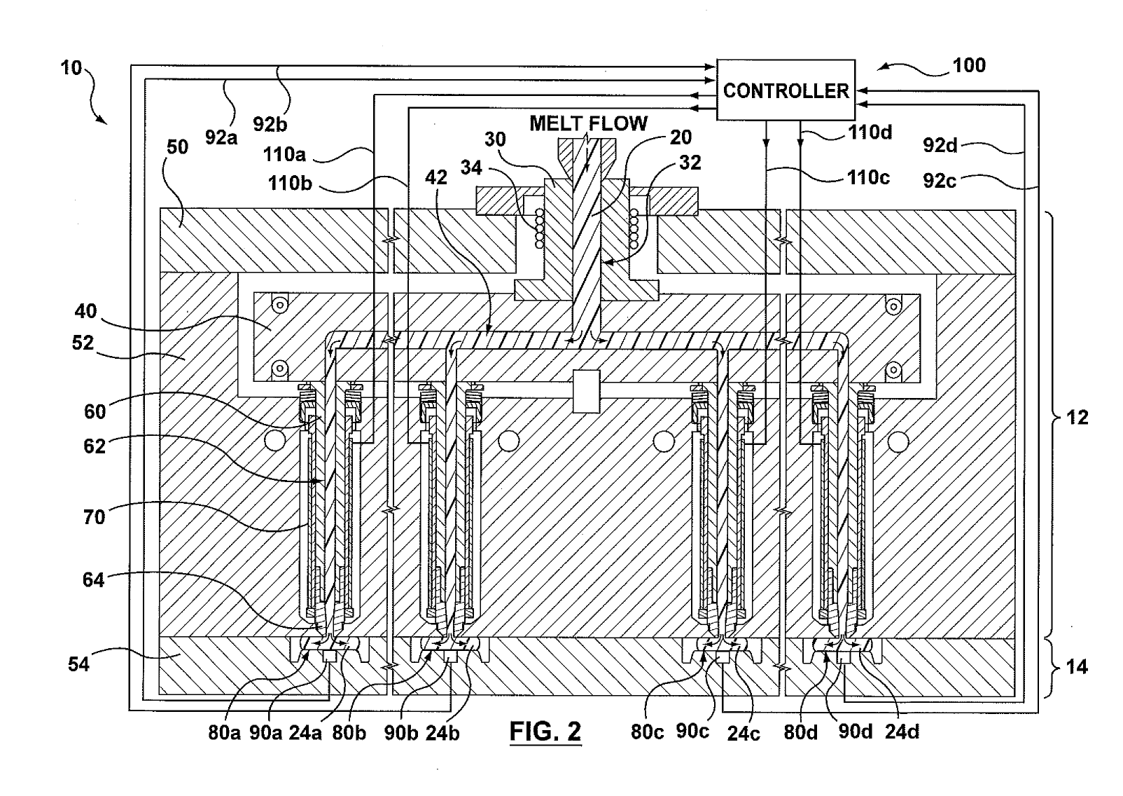

The hot runner system of FIG. 2 includes a controller 100 that is configured to receive feedback through transmission lines 92a, 92b, 92c, 92d from sensors 90a, 90b, 90c, 90d that are configured to detect one or more physical properties of the dispensed melt 24a, 24b, 24c, 24d while located in respective mold cavities 80a, 80b, 80c, 80d. In some embodiments, such properties are structural part-based information, such as the weight or dimensions of the dispensed melt of each of the mold cavities, or the rate of melt filling of each of the mold cavities; or other physical part-based information, such as the temperature or the pressure of the dispensed melt in the mold cavities. In some embodiments, such physical properties include information about the mold cavities themselves, such as the temperature or pressure measured at certain locations within or adjacent to the mold cavities. While sensors 90a, 90b, 90c, 90d are illustrated in FIG. 2 to be located in close proximity to respective mold cavities, it can be appreciated that sensors configured to detect one or more physical properties of the dispensed melt can be located in any suitable location, for example, in regions of the hot runner further away from the mold cavities.

The sensed physical properties provide a basis for adjustments to be made to respective heaters 70, particularly those heaters that correspond to the nozzles that dispense into the mold cavities where the physical properties were sensed. As discussed herein, adjustments may be made to the appropriate heaters so that the amount of dispensed melt 24a, 24b, 24c, 24d into corresponding mold cavities is substantially equal.

In operation, melt 20 flows through each of the nozzles 60 under heat provided by the heaters 70. When melt 20 exits out of the tip 64 of each nozzle and enters into corresponding mold cavities 80a, 80b, 80c, 80d, sensors 90a, 90b, 90c, 90d detect in each mold cavity an appropriate physical property of the melt, such as a structural property (e.g., weight, dimensions, volume, rate of fill, etc. of the dispensed melt) or a different physical property (e.g., temperature, pressure, viscosity, etc. of the melt). In various embodiments, such properties may be sensed during or after filling of the mold cavities, and/or during or after ejection of the molded part from the mold cavities.

If, for example, the controller receives an indication that the weight or volume of the dispensed melt within one of the mold cavities is different (or substantially different, e.g., greater than 10%, 15%, 20% difference in weight or volume) from that of the dispensed melt within another of the mold cavities (or, e.g., rate of flow into the mold cavities), the controller makes a determination that the amount of dispensed melt within respective mold cavities is unbalanced. As a result, to ensure that the amount of dispensed melt in each of the mold cavities is about the same, an adjustment signal is sent through transmission lines 110a, 110b, 110c, 110d to the appropriate heaters corresponding to each of the nozzles, to correct for the imbalance.

Contrasting the system of FIG. 1, which shows an uneven distribution of dispensed melt 22a, 22b, 22c, 22d in respective mold cavities, in the embodiment of FIG. 2, the output from the heaters 70 of each of the nozzles is appropriately adjusted based on the sensed property information of the dispensed melt in each of the mold cavities. For instance, for the embodiment of FIG. 2, during production, if the dispensed melt 24a, 24c in mold cavities 80a, 80c is initially less than the dispensed melt 24b, 24d in mold cavities 80b, 80d, then the heat output from heaters corresponding to mold cavities 80a, 80c is increased relative to the heat output from heaters corresponding to mold cavities 80b, 80d. This adjustment in heat output results in the amount of melt dispensed into mold cavities 80a, 80c to be increased so as to be balanced with the amount of melt dispensed into mold cavities 80b, 80d. Accordingly, the resulting dispensed melt 24a, 24b, 24c, 24d in each of the cavities 80a, 80b, 80c, 80d of FIG. 2 is about equal. In some embodiments, the output of other heaters located throughout the hot runner may also be appropriately adjusted, in concert or independently.

The inventors have further appreciated that prior injection molding systems have not implemented a controller system that independently controls each heater corresponding to the same nozzle as well as heaters across different nozzles in a hot runner. For instance, in conventional hot runner systems, multiple nozzle heaters used to control flow rate of a melt stream through a single nozzle are coupled together in a single controller zone where a signal aimed at adjusting the output of one of the heaters on the nozzle is also transmitted to the other heater(s) of the same nozzle. That is, control of balance heaters and tip heaters is commonly coupled together. Other systems have multiple nozzle heaters where one heater on the nozzle is coupled to one heater on another nozzle such that these heaters are part of a single controller zone where a signal aimed at adjusting the output of one of the heaters is also transmitted to the other heater(s) of the system. For example, control of separate balance heaters corresponding to separate nozzles is commonly coupled together.

The above control architectures have been made to decrease complexity by reducing controller zone requirements; for example, a signal that affects every heater that may be disposed along a nozzle will simplify overall controller architecture. However, such an arrangement results in limitations where both the balance across mold cavities and the quality of the injection molded material require independent adjustment. Accordingly, a control functionality for hot runners that incorporates individual adjustment for balance heaters separate from one another on different nozzles and separate from tip heaters for the same nozzle is provided.

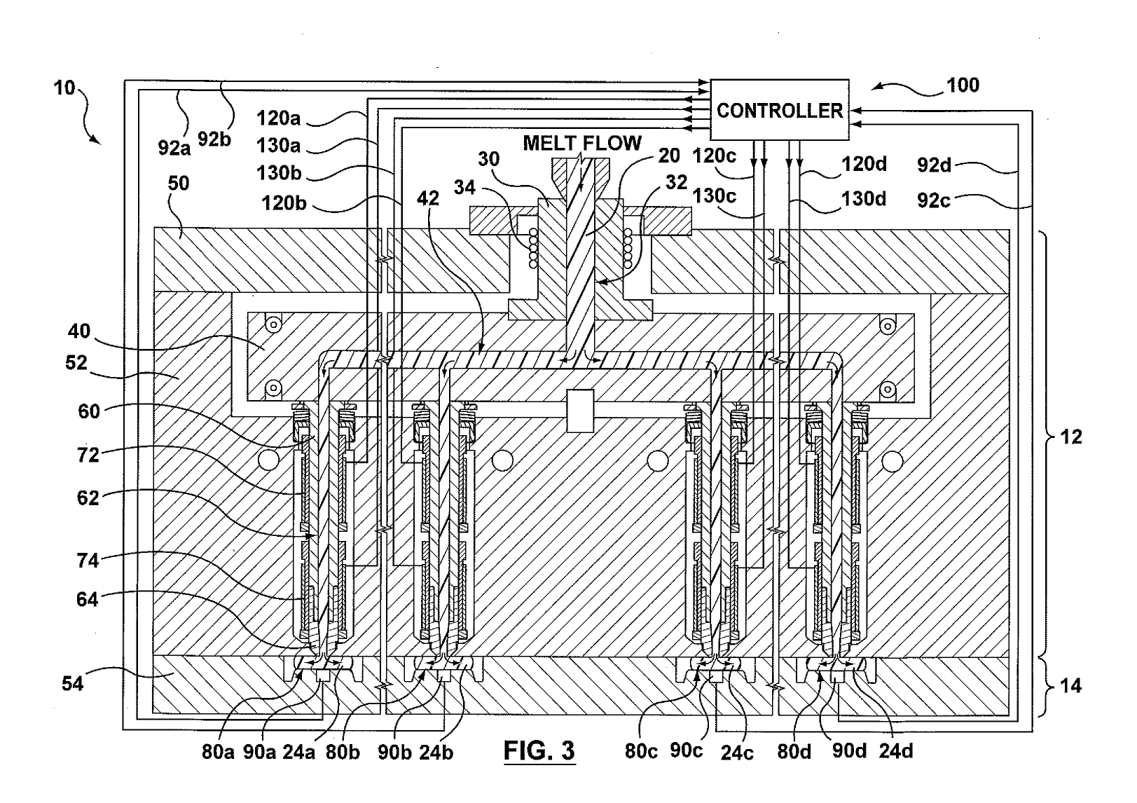

In the embodiment shown in FIG. 3, the injection molding system 10 includes a hot runner 12 where each nozzle 60 is associated with a separate balance heater 72 and tip heater 74 each for heating different portions of the nozzle. The balance heater 72 is located upstream of the tip heater 74 and is configured to heat the body of the nozzle 60 and to control the rate of flow of the melt through the nozzle; hence, the balance heater also controls the amount of melt that is ultimately dispensed into the corresponding mold cavity. The tip heater 74, discussed further below, is configured to heat the tip 64 of the nozzle.

Similar to that shown above with respect to the embodiment of FIG. 2, the embodiment of FIG. 3 includes sensors 90a, 90b, 90c, 90d connected to the controller through transmission lines 92a, 92b, 92c, 92d. The controller outputs respective control signals to each of the balance heaters 72 through transmission lines 120a, 120b, 120c, 120d; and, separately, to the tip heaters 74 through transmission lines 130a, 130b, 130c, 130d. As the controller receives property information from respective sensor(s), feedback signals from the controller may be based on comparisons of the physical properties from each cavity to each other; or, feedback signals from the controller may be based on comparisons of the physical properties from each cavity to those provided by appropriate reference values (e.g., from a standard look up table with stored values). It can be appreciated that the control system may be further set up to provide independent control/feedback to other heaters located throughout the injection molding system so as to provide for the manufacture of uniform injection molded parts.

As discussed above, a balance heater 72 is useful for controlling the amount of the melt that is dispensed into the mold cavity. The controller 100 coordinates heat output from each of the balance heaters 72 corresponding to different nozzles 60 such that injection molded parts formed from the melt, originally injected into the sprue, are balanced across mold cavities. Accordingly, when a melt enters into a nozzle, in some cases, the controller provides a signal that directs the balance heater 72 to increase, decrease or maintain its heat output, resulting in even flow of the melt in respective nozzles into corresponding mold cavities.

In accordance with various embodiments, if the melt dispensed into one mold cavity 80a is detected by the sensor 90a associated with that mold cavity to be less than that dispensed into other mold cavities, then the controller 100 may receive that feedback from the transmission line 92a. After making a determination that the balance heater 72 should increase its heat output to maintain uniformity of the injection molded parts, the controller may then provide an appropriate signal through the transmission line 120a that directs the individual balance heater 72 to adjust its heat output accordingly. At the same time, balance heaters connected to transmission lines 120b, 120c, 120d are directed to maintain the same level of heat output as before.

The relative increase in heat output from the balance heater connected to transmission line 120a results in an increase in temperature in the channel of the nozzle, giving rise to a greater rate of flow of the melt through the channel and toward the mold cavity. A greater rate of flow of the melt results in a larger volume dispensed into the mold cavity, accounting for the previous shortfall in the amount of initially dispensed melt. Such an adjustment allows the injection molding system to achieve a suitable balance of dispensed melt of originally injected material into each of the mold cavities.

Alternatively, if the melt dispensed into a mold cavity is too much, or greater than that dispensed into other mold cavities, then the same feedback process may occur; yet this time, the controller makes a determination and provides a signal through the appropriate transmission lines that directs that individual balance heater to decrease its heat output relative to other balance heaters. Such a decrease in heat output results in a reduction in temperature in the channel of the nozzle, resulting in a slower rate of flow of the melt through the channel and toward the mold cavity. A slower rate of flow of the melt results in a smaller volume dispensed into the mold cavity, resulting in a suitable balance of dispensed melt of originally injected material into each of the mold cavities.

In some embodiments, the rate of fill of each mold cavity is measured and equalized. For example, the arrival time of the plastic flow front within each cavity at a location common to all cavities may be equalized according to methods described herein. That is, the time at which a plastic flow front arrives at a particular location of each cavity may be sensed. If the corresponding arrival time for each of the cavities is different, then appropriate adjustments may be made so that the arrival time for each of the cavities becomes essentially the same.

In some embodiments, balance heaters are each individually controlled where, for example, separate transmission lines run from the controller to each and every balance heater. Thus, the temperature of the body of each nozzle, due to the output from the corresponding balance heater, may be separately controlled. Alternatively, small groups of balance heaters may be controlled together. For example, a single transmission line may run from the controller to a small group (e.g., 2, 3, 4, etc. heaters) of balance heaters; and other transmission lines may connect the controller to other balance heaters or groups of balance heaters.

Arrangements described herein where balance heaters corresponding to each nozzle or a subset of nozzles are separately and independently controlled are advantageous over systems where all of the balance heaters are controlled together as a group. Here, control of multiple balance heaters independently provides for a greater granularity of control of melt flow through the system and into respective mold cavities than prior systems. Such control allows for effective and efficient balancing of material for producing injection molded parts. Similarly, separate and independent control of other heaters throughout the injection molding system may also be provided.

The tip heater 74 is located downstream from the balance heater 72 adjacent to the tip of the nozzle. The tip heater 74 is useful for controlling the quality of the melt as it exits from the nozzle and flows into the mold cavity. In some cases, upon exit from the tip of the nozzle, it would be undesirable for the melt to exhibit behavior (e.g., due to viscosity or other physical characteristics) in a manner that results in an uneven shape of the melt (e.g., stretching, undesirable cohesion, stringing).

For example, if there is a tendency for the melt to be too viscous when the melt is dispensed from the tip of the nozzle, the controller 100 may provide a signal through a transmission line 130 that directs the tip heater 74 to increase its heat output. Such an increase in heat output results in an increase in temperature at the tip of the nozzle, resulting in the melt exhibiting less viscous behavior so as to more readily, and desirably, flow into the mold cavity. Alternatively, if the melt is determined not to be viscous enough, the controller may provide a signal that directs the tip heater 74 to decrease its power output resulting in the melt exhibiting more cohesive behavior as it flows into the mold cavity.

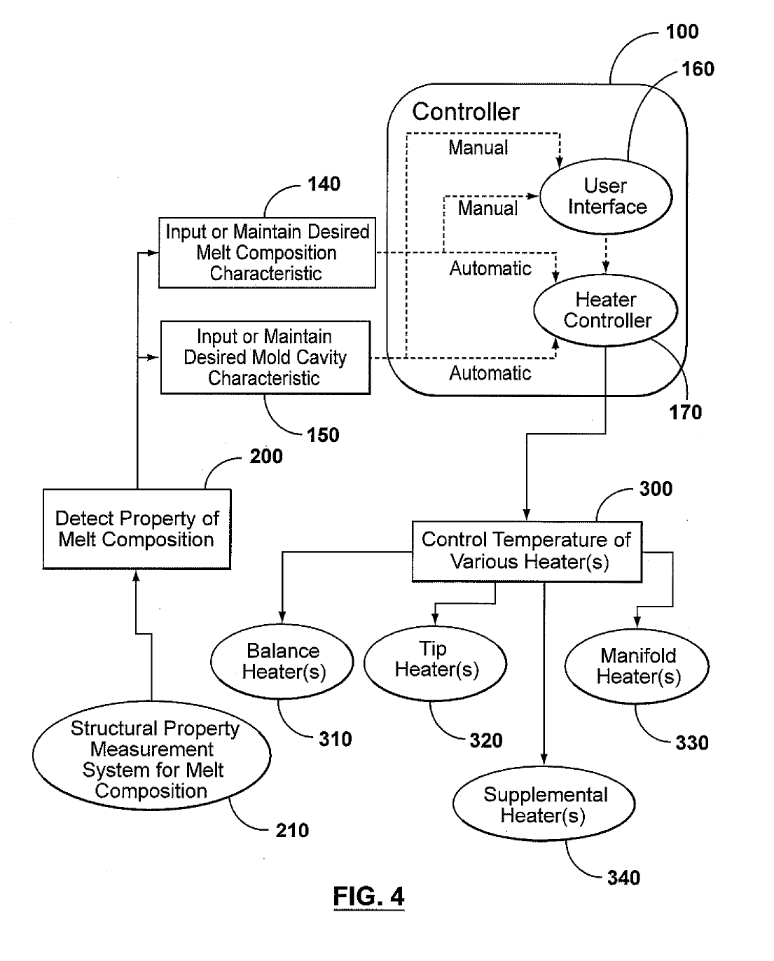

Thus, contrary to conventional hot runner systems, such arrangements described herein decouples the 1) control of the amount and rate of flow of the melt dispensed into the mold cavity; and 2) control of the quality of the melt as it is dispensed into the mold cavity. In accordance with various embodiments presented herein, injection molding systems have controllers that are set up to control these features separately and independently through direct connections with individual balance heaters and tip heaters or, in some cases, other heaters located throughout the injection molding system. FIG. 4 depicts a schematic of an exemplary control architecture in accordance with embodiments described. The controller 100 receives input as to what a desired characteristic would be for the melt 140 (e.g., weight, dimensions, shape, viscosity, etc. of the melt) and/or what a desired characteristic would be for the mold cavities 150 (e.g., temperature, pressure, etc. of the mold cavity). For instance, a desired characteristic input into the controller may be that the weight or volume difference of the corresponding melt dispensed into each of the mold cavities is less than a certain percentage (e.g., within 20%, 15%, 10%, 5%) of each other. Another desired characteristic input into the controller, for example, may be that the melt completely fill a particular space of the mold cavity by a certain time increment. Or, another desired characteristic may be that the mold cavity maintain a particular range of temperature and/or pressure. Still another desired characteristic may be for the flow front of the melt to reach the mold cavity after a designated period of time. Such characteristics may be manually or automatically input into the controller such that an appropriate signal with this information is transmitted to a heater controller 170 which, in turn, controls each of the heaters of the injection molding system.

In some embodiments, the controller may have an appropriate user interface 160 through which a user may manually input into the heater controller 170 one or more desired characteristics for the melt and/or mold cavities. Alternatively, or in addition, one or more desired characteristics of the melt and/or mold cavities may be automatically input to the heater controller 170. In some embodiments, an automatic input of a desired characteristic may be provided to the heater controller as an input having been left over from a previous injection molding cycle. Or, an automatic input to the heater controller may arise as a default setting in the controller system.

The heater controller 170 processes the transmitted signal and, through a suitable algorithm, makes a determination as to which heater(s) of the system are to be adjusted and, if required, what type of adjustment is to be made to each heater. The heater controller 170 may then transmit a control signal to the appropriate heater causing that heater to adjust its output 300. Alternatively, in some embodiments, an operator determines what adjustments are to be made to particular heaters of the hot runner and inputs those adjustments into the heater controller.

For example, if it is desired for the amount of melt dispensed into each mold cavity to be balanced, then the heater controller may make a determination that the power output, resulting in a certain heat output, by a certain subset of balance heaters 310 is to be increased while the power output for a different subset of balance heaters is to remain constant, or be decreased. Based on this determination, the heater controller may be suitably configured to transmit one or more appropriate signals to the corresponding balance heater(s) that require the particular adjustment in power output. Once the signal(s) are transmitted to and received by the heater(s), the power output of the heater(s) are modified accordingly.

Other heaters in the system, such as tip heaters 320, manifold heaters 330 and/or supplemental heaters 340, may also be adjusted so as to suitably manipulate the melt. For instance, as discussed above, tip heaters may be adjusted so as to affect the quality of the melt as it exits the tip of the nozzle and enters into the mold cavity. In some cases, if a tip heater does not provide a suitable temperature during exit of a melt from the tip, the melt may exhibit inconsistency in quality (e.g., exhibit string-like behavior, having lumps, being uneven, etc.). However, appropriately set tip heaters may result in melt quality that is of a desirable consistency across mold cavities. Or, manifold heaters may be adjusted to affect overall flow of the melt (e.g., rate of flow, etc.) from the manifold channel, or optionally the sprue channel, and into separate nozzles. The heat output of supplemental heaters may also be adjusted depending on the desired melt flow behavior.

In some embodiments, such as that shown in FIG. 2, a nozzle has a single heater that acts as both a balance heater and a tip heater. Or, as provided in FIG. 3, a nozzle may have multiple heaters, such as a balance heater for affecting the amount of melt dispensed into a mold cavity, and a tip heater for affecting the quality of the dispensed melt. It can be appreciated that suitable signals may be transmitted to any of the heaters shown, or heaters not shown, in the schematic of FIG. 4.

Any suitable heater may be incorporated into the injection molding system. In some embodiments, heaters may be coiled heaters, film heaters, thermoelectric heaters, electric resistive heaters, cable heaters, band heaters, cartridge heaters, aluminum nitride heaters, ceramic heaters, plasma or other layered heater, or any other suitable type of heater appropriate for incorporation into a hot runner. Other heaters besides balance heaters, tip heaters, manifold heaters or supplemental heaters, configured to provide additional heat to the melt at different stages of injection molding may be provided at various locations throughout the hot runner, such as along the sprue bushing, along the melt channel, at various regions of the nozzles, etc.

At the beginning stages of injection molding where melt is initially introduced into the manifold and flowed into the nozzles for dispense into the mold cavities, the initial heat output of each of the balance heaters may be set to be substantially equal (e.g., according to a default set point), or may be such that the expected amount of flow of melt into each of the mold cavities is about equal. However, despite the initial heat output of the balance heaters being set such that the expected amount of melt that flows from the nozzles into each mold cavity is the same, the actual amount of melt that is dispensed into respective mold cavities may vary. As mentioned previously, such a difference may be due to, for example, variance in location of the nozzles along the manifold. For instance, the total heat input into a nozzle more central to the manifold, by virtue of its location in the manifold, may be greater than the total heat input into a nozzle located at a periphery of the manifold. Or, as another possibility, the heaters may be calibrated differently (even slightly) with respect to one another, resulting in an overall imbalance of flow into separate mold cavities.

Upon dispense of the melt into the mold cavity, one or more sensors may detect particular physical properties of the dispensed melt in the mold cavity 200. Such information may assist the controller, or a user, to determine whether the amount of melt dispensed into respective mold cavities of the injection molding system is desirable (e.g., balanced).

In some embodiments, a structural property measurement system 210 (e.g., sensors)associated with the mold cavities may detect one or more physical properties of the melt dispensed in each mold cavity, such as the amount of dispensed melt, the rate of fill into the mold cavities, or the level to which the melt has filled each of the mold cavities. For example, sensors may detect the relative weight of the dispensed melt in one or more mold cavities. Other properties of the melt may be detected, such as the volume of melt that has entered into the mold cavity, certain dimensions of the melt in the mold cavity, rate of melt flow at various stages, temperature of the melt, pressure of the melt, viscosity of the melt, or other properties. As described above, such measurements may be performed in the mold cavity during and/or after injection of the melt is complete. Such measurements may also be performed on the molded part during or after ejection of the part(s) from the cavities. For example, an automated system (e.g., robot) may have weight/vision sensors that are configured to take measurements as molded parts are removed from the cavities, or after the molded parts are removed from the cavities.

Sensors for detecting one or more structural properties of the melt in respective mold cavities may include, for example, weight sensors (e.g., scales), optical imaging devices, machine vision systems (e.g., automated imaging-based inspection and analysis of the mold cavities, robotic systems with appropriate sensors), etc. In some embodiments, the mold cavity includes a scale which measures and provides an immediate indication of the weight of the dispensed melt as it enters into the mold cavity. In some embodiments, for a manually operated system, a user interface prompts an operator to place the dispensed melt having been deposited into a mold cavity (e.g., a partial or fully completed injection molded part) on a scale for weighing. Based on the information provided from the scale, the user interface provides the operator with a suggestion as to how to adjust the heaters of the hot runner to achieve desired characteristics (e.g., balance between injection molded parts). Or alternatively, based on the information provided from the scale, the heater controller makes a determination of how the heaters of the hot runner should be adjusted to achieve the desired characteristics (e.g., balanced melt in the mold cavities).

Other types of sensors may be used to detect other types of non-structural physical properties of the melt as well, such as temperature, pressure, viscosity, etc. In this regard, thermocouples, pressure sensors, capacitive sensors, force sensors, ultrasonic transducers/sensors may be used. For example, the sensors may detect any measureable property of the dispensed melt of each of the plurality of mold cavities, prior to or after complete filling of the mold cavities.

As discussed, a desirable characteristic input to the controller may be for the melt dispensed between mold cavities to be balanced. Though, during filling of the mold cavities, the amount of dispensed melt into one mold cavity may be measured by a sensor to be substantially less than the weight of the dispensed melt in other mold cavities. This information regarding dispensed melt imbalance is passed along to the controller where a determination is made by the heater controller, or an operator, as to whether an adjustment to any of the heaters is required.

In this case, the heater controller 170 may provide a suitable signal to the balance heater corresponding to the nozzle aligned with the mold cavity that is measured to have a weight of the dispensed melt that is substantially less than that of the others. Transmission of this signal may result in an increased heat output from this particular balance heater as compared with other balance heaters that correspond to nozzles having dispensed a greater amount of melt. Accordingly, the rate of flow of the melt into the mold cavity having an undersupplied amount of dispensed melt increases relative to that of other mold cavities. Once the amount of dispensed melt into each of the mold cavities is sensed to be about equal and this information is communicated to the heater controller, then the heater controller may subsequently transmit a signal to the appropriate heater(s) that brings the rate of flow of melt from each of the nozzles into corresponding mold cavities into alignment.

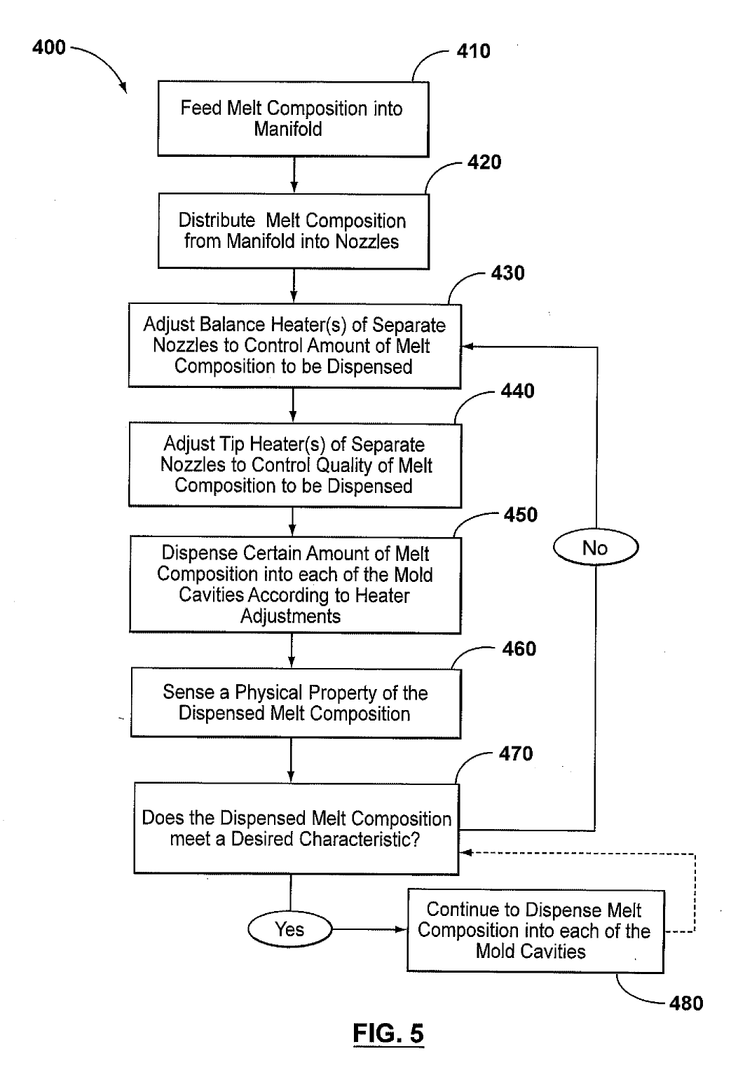

FIG. 5 depicts a process flow diagram 400 indicating operation of the feedback system employed for certain embodiments of the present disclosure. At block 410, the melt is fed from the sprue into the manifold. At block 420, the melt flows through the manifold channel and is distributed into each of the nozzles branching from the main manifold channel. At block 430, the heat output of one or more balance heaters of the nozzles in the hot runner are optionally adjusted to control the amount of melt to be dispensed into the mold cavity. At block 440, the heat output of one or more tip heaters of the nozzles in the hot runner are optionally adjusted to control the quality of the melt that is dispensed into the mold cavity. At block 450, the melt is dispensed into each of the mold cavities in accordance with the adjustments to heat output of the heaters.

At block 460, sensors (e.g., situated at the mold cavities) sense one or more physical properties (e.g., structural properties) of the dispensed melt. Properties of the dispensed melt may be measured/sensed while in each of the mold cavities (e.g., during or after injection within the mold cavity), or after removal/ejection from the mold cavities. The sensed property is input into the controller and an inquiry is made as to whether the dispensed melt of each of the mold cavities meets a desired characteristic (e.g., that the injection molded parts between each of the mold cavities are balanced). This inquiry can be based on a number of different types of information. For example, if the desired characteristic is for balance of injection molded parts, and the percent weight or volume difference of dispensed melt within each of the mold cavities, the molded part itself, is less than 5%, or less than 10%, then the mold cavities may be considered balanced. If the answer to this inquiry is “no,” then the process flow continues back to block 430 where one or more balance heaters are adjusted to rectify this imbalance in the dispensed melt. If the answer to this inquiry is “yes,” then the parameters (e.g., heat output) within the hot runner remain and no heater adjustments are required.

At block 480, the nozzles continue to dispense melt under the same parameters into each of the mold cavities. After an increment of time, the process flow may follow the dotted arrow toward block 470 where the same inquiry may be made regarding whether the dispensed melt of each of the mold cavities (e.g., in each of the mold cavities or having been removed from the mold cavities as a molded part) meets the desired characteristic. The process flow may then continue as described above until the mold cavities (in the forming the current part, or another part) are filled. In some embodiments, the above described flow may be an iterative process where structural properties of the dispensed melt are continuously monitored and heater parameters adjusted until the mold cavities are suitably filled or until a subsequent molded part is formed, resulting in desired dispensed melt characteristics (e.g., balancing) of injection molded parts.

In some embodiments, operation of the heater controller may be a largely manual process where an operator provides guidance regarding the degree of adjustment for each area to be heated based on structural properties measured by appropriate sensors. As such, in the beginning stages of production, the controller may be set to a default state, for example, transmitting signals to the balance heater and the tip heater so as to have the same initial heater set point. An operator may then determine whether heater adjustments are required and subsequently input into a user interface the appropriate adjustments. Such input to the controller may result in increase, decrease or maintain the heat output of one or more balance heaters so as to influence the fill rate of mold cavities corresponding to nozzles affected by the balance heater(s).

The user interface of the controller may display the magnitude of the change in the balance heater (or other heater(s) of the system), for example, as a dimensionless integer value, or an actual measured value such as temperature or voltage, based on the degree of deviation from the set point of the tip heater, or other heaters (e.g., balance heaters). When adjustment of the heaters of the hot runner are manually controlled, the operator may be provided with appropriate reference information (e.g., in the form of tables, charts, electronic presentation, etc.) that lists various parameters that have been determined to provide useful guidance as to the type of adjustment of the balance heaters, tip heaters and/or other heaters required to achieve desired results. For example, such parameters that influence how the heaters should be adjusted may include the type of melt, the shot size of the mold cavity, the flow rate of the melt, the residence time of the melt in the mold cavity, the current degree of imbalance of dispensed melt between mold cavities, etc. For heater adjustments that are automatic, such parameters may be provided to a controller as a reference for determining what signal(s) are to be transmitted to the appropriate heater(s) for appropriate adjustments to be made.

In some embodiments, an operator may enter certain desired characteristics, such as the desired weight, measurements, dimensions and/or volume for particular injection molded parts from each mold cavity into the heater controller. An algorithm in the heater controller may then determine the recommended adjustments to be made to particular heaters of the hot runner and automatically makes the adjustments to the heaters to achieve the desired result(s). For example, an operator may enter a desired weight characteristic of the dispensed melt into the heater controller. After an initial stage of production where melt is flowed into respective mold cavities, weight information for each mold cavity (e.g., from scales employed with each mold cavity) or molded part may subsequently be input to the heater controller and a determination is made (e.g., based on a comparison of dispensed melt in the cavities and/or molded part(s) to each other and/or to stored reference values) as to what adjustments should be made to the heaters. Alternatively, or in addition, a machine vision system provides automated measurement data to the heater controller regarding the dispensed melt in each mold cavity and/or the molded part(s). Based on this information, the heater controller makes appropriate changes to the settings (e.g., heat output) of each of the heaters, for example, so as to improve balance between injection molded parts.

In general, control strategies described herein provide for adjustments to be made such that injection molded parts may be uniformly made simply and efficiently. Such functionality may separate out adjustments in balance control from adjustments that affect melt quality (e.g., tip heater areas). In some embodiments, injection molding systems described herein may exhibit self-learning capabilities where controllers “learn” over time how certain changes affect actual results to the injection molded parts, and improved adjustments to the heater elements of the hot runner can be made.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the foregoing description and drawings are by way of example only.

What is claimed is:

1. An injection molding system, comprising:
a hot runner including:
a plurality of nozzles, each constructed and arranged to dispense a melt into one or more corresponding mold cavities, each nozzle having a nozzle body and a nozzle tip coupled to the body, and
a plurality of heaters, each constructed and arranged to heat the melt in at least one corresponding nozzle of the plurality of nozzles;
at least one sensor configured to sense a structural property of the dispensed melt of each of the one or more mold cavities during the dispensing of the melt; and
a heater controller configured to adjust a heat output of the plurality of heaters based on the sensed structural property of the dispensed melt of each of the one or more mold cavities.

2. The injection molding system of claim 1, wherein the heater controller is configured to adjust the heat output of the plurality of heaters such that an amount of the dispensed melt of each of the one or more mold cavities is about equal.

3. The injection molding system of claim 1, wherein the controller is configured to adjust the heat output of the plurality of heaters such that a weight difference in amount of the dispensed melt of each of the one or more mold cavities is less than about 10% of each other during or after filling.

4. The injection molding system of claim 1, wherein the at least one sensor is configured to sense a weight, a dimension or a volume of the dispensed melt of each of the one or more mold cavities during or after filling.

5. The injection molding system of claim 1, wherein the at least one sensor is configured to sense a level to which the dispensed melt has filled each of the one or more mold cavities.

6. The injection molding system of claim 1, wherein the at least one sensor is configured to sense the structural property of the dispensed melt of each of the one or more mold cavities prior to complete filling.

7. The injection molding system of claim 1, wherein each of the plurality of heaters is disposed at a region upstream from a corresponding tip of each of the plurality of nozzles.

8. The injection molding system of claim 7, wherein each of the plurality of heaters is disposed adjacent to a channel of each of the plurality of nozzles.

9. The injection molding system of claim 1, wherein the plurality of heaters comprise a balance heater constructed and arranged to heat an area of the nozzle body of one of the plurality of nozzles and a tip heater constructed and arranged to heat an area of the nozzle tip of the nozzle, the tip heater disposed adjacent to the tip of the nozzle and at a region separate and downstream from the balance heater.

10. The injection molding system of claim 1, in combination with the one or more mold cavities.

11. The injection molding system of claim 1, wherein the at least one sensor is configured to sense the structural property of the dispensed melt in each of the one or more mold cavities.

12. The injection molding system of claim 1, wherein the at least one sensor is configured to sense the structural property of the dispensed melt after complete filling.

13. The injection molding system of claim 1, wherein the at least one sensor is configured to sense the structural property of a molded part formed from the dispensed melt.

14. A process of controlling a melt in an injection molding system having a plurality of nozzles, the process comprising:
dispensing the melt from a plurality of nozzles into one or more mold cavities each corresponding to a separate nozzle;
sensing a structural property of the dispensed melt of each of the one or more mold cavities; and
adjusting a heat output of at least one heater based on the sensed structural property of the dispensed melt of each of the one or more mold cavities, wherein the at least one heater comprises a tip heater constructed and arranged to heat an area of a tip of the nozzle.

15. The process of claim 14, wherein adjusting a heat output of at least one heater results in an amount of the dispensed melt of each of the one or more mold cavities to be about equal.

16. The process of claim 14, wherein adjusting a heat output of at least one heater results in percent weight difference in amount of the dispensed melt of each of the one or more mold cavities to be less than about 10% of each other during or after filling.

17. The process of claim 14, wherein adjusting a heat output of at least one heater results in an increase in rate of the amount of melt that is dispensed into at least one of the one or more mold cavities.

18. The process of claim 14, wherein adjusting a heat output of at least one heater results in a decrease in rate of the amount of melt that is dispensed into at least one of the one or more mold cavities.

19. The process of claim 14, wherein sensing a structural property of the dispensed melt of each of the one or more mold cavities comprises sensing a weight, a dimension or a volume of the dispensed melt of each of the one or more mold cavities during or after filling.

20. The process of claim 14, wherein sensing a structural property of the dispensed melt of each of the one or more mold cavities comprises sensing a level to which the dispensed melt has filled each of the one or more mold cavities.

21. The process of claim 14, wherein sensing a structural property of the dispensed melt of each of the one or more mold cavities occurs prior to complete filling of each of the one or more mold cavities.

22. The process of claim 14, wherein the at least one heater comprises a balance heater constructed and arranged to heat an area of a body of a nozzle of the plurality of nozzles.

23. The process of claim 14, wherein each of the steps of sensing a structural property of the dispensed melt of each of the one or more mold cavities and adjusting a heat output of at least one heater based on the sensed structural property of the dispensed melt of each of the one or more mold cavities occurs automatically.

24. The process of claim 14, wherein adjusting a heat output of at least one heater based, on the sensed structural property of the dispensed melt of each of the one or more mold cavities comprises inputting a desired characteristic of the melt into a controller via a user interface.

25. The process of claim 14, further comprising comparing the sensed structural property of the dispensed melt of each of the one or more mold cavities to each other.

26. The process of claim 14, further comprising comparing the sensed structural property of the dispensed melt of each of the one or more mold cavities to a stored value.

27. The process of claim 14, wherein adjusting a heat output of at least one heater based on the sensed structural property of the dispensed melt comprises adjusting the heat output of the at least one heater based on the sensed structural property of a molded part formed from the dispensed melt.

28. The process of claim 14, wherein sensing a structural property of the dispensed melt of each of the one or more mold cavities comprises sensing the structural property of the dispensed melt in each of the one or more mold cavities.

29. The process of claim 14, wherein sensing a structural property of the dispensed melt of each of the one or more mold cavities comprises sensing the structural property of the dispensed melt after complete filling of each of the one or more mold cavities.

30. An injection molding system, comprising:
a hot runner including:
a plurality of nozzles, each constructed and arranged to dispense a melt into one or more corresponding mold cavities, each nozzle having a nozzle body and a nozzle tip coupled to the body,
a plurality of balance heaters, each constructed and arranged to heat an area of a nozzle body of a corresponding nozzle, and
a plurality of tip heaters, each constructed and arranged to heat an area of a nozzle tip of a corresponding nozzle; and
a heater controller configured to adjust a heat output of each balance heater independently of each other.

31. The injection molding system of claim 30, wherein the heater controller is configured to independently adjust a heat output of each tip heater.

32. The injection molding system of claim 30, wherein the balance heater is disposed at a region upstream from the tip of the nozzle.

33. The injection molding system of claim 30, wherein the tip heater is disposed adjacent to the tip of the nozzle and at a region separate and downstream from the balance heater.

34. The injection molding system of claim 30, further comprising at least one sensor configured to sense a structural property of the dispensed melt of the one or more mold cavities.

35. The injection molding system of claim 34, wherein the at least one sensor is configured to sense at least one of a weight, a dimension or a volume of the dispensed melt of the one or more mold cavities.

36. The injection molding system of claim 34, wherein the at least one sensor is configured to sense a level to which the dispensed melt has filled each of the one or more mold cavities.

37. The injection molding system of claim 30, wherein the heater controller is configured to adjust the heat output of each balance heater such that an amount of the dispensed melt of each of the one or more mold cavities is about equal.

38. The injection molding system of claim 30, wherein the heater controller is configured to adjust the heat output of each balance heater such that weight difference in amount of the dispensed melt of each of the one or more mold cavities is less than about 10% of each other during filling.

39. The injection molding system of claim 30, in combination with the one or more mold cavities.

40. A process of controlling a melt in an injection molding system, the process comprising:
dispensing the melt from a plurality of nozzles into a one or more corresponding mold cavities each corresponding to a separate nozzle;
adjusting a heat output of each of a plurality of balance heaters corresponding to each of the plurality of nozzles to heat an area of a nozzle body of the corresponding nozzle independently of each other; and
adjusting a heat output of each of a plurality of tip heaters corresponding to each of the plurality of nozzles to heat an area of a nozzle tip of the corresponding nozzle.

41. The process of claim 40, wherein adjusting a heat output of each of a plurality of balance heaters comprises adjusting the heat output of each of the plurality of balance heaters such that an amount of the dispensed melt of each of the one or more mold cavities is about equal.

42. The process of claim 40, wherein adjusting a heat output of each of a plurality of balance heaters comprises adjusting the heat output of each of the plurality of balance heaters such that a percent weight difference in amount of the dispensed melt of each of the one or more mold cavities is less than about 10% of each other during filling.

43. The process of claim 40, further comprising sensing a structural property of the dispensed melt of the one or more mild cavities.

44. The process of claim 43, wherein sensing a structural property of the dispensed melt of the one or more mold cavities comprises sensing a weight, a dimension, or a volume of the melt in the one or more mold cavities.

45. The process of claim 40, wherein adjusting a heat output of each of a plurality of balance heaters comprises controlling an amount of melt that is dispensed into each of the one or more mold cavities.

46. The process of claim 40, further comprising comparing the sensed structural property of the dispensed melt of each of the one or more mold cavities to each other.

47. The process of claim 40, further comprising comparing the sensed structural property of the dispensed melt of each of the one or more mold cavities to a stored value.

48. The process of claim 14, wherein sensing a structural property of the dispensed melt of each of the one or more mold cavities comprises sensing a structural property of the dispensed melt of each of the one or more mold cavities during the step of dispensing.

49. The injection molding system of claim 30, wherein each of the plurality of balance heaters is configured to control an amount of melt that is dispensed into corresponding mold cavities; and wherein each of the plurality of tip heaters is configured to control a quality of the melt upon exit from the tip of the corresponding nozzle.

50. The process of controlling a melt in an injection molding system of claim 40, wherein the heat output of each of a plurality of balance heaters corresponding to each of the plurality of nozzles is adjusted to control an amount of melt that is dispensed into corresponding mold cavities; and wherein the heat output of each of a plurality of tip heaters corresponding to each of the plurality of nozzles is adjusted to control a quality of the melt upon exit from the tip of the corresponding nozzle.
